(19) United States
(12) Patent Application Publication
(10) Pub. No.: US 2010/0210273 A1
(43) Pub. Date: Aug. 19, 2010

(54) Apparatus and method for supporting femto based station in wireless communication system

(75) Inventors: Byung-Wook Jun, Seoul (KR); Jae-Hee Cho, Seoul (KR); Yung-Soo Kim, Seongnam-si (KR); Jong-Hyung Kwun, Seoul (KR); Ju-Mi Lee, Seoul (KR); Young-Bo Cho, Seongnam-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/658,426

(22) Filed: Feb. 10, 2010

(30) Foreign Application Priority Data
Feb. 13, 2009 (KR) 10-2009-0011831

(51) Int. Cl. H04W 72/00; H04W 4/00

(52) U.S. Cl. 455/450; 455/422.1

(57) ABSTRACT

An apparatus and method for operating the femto BS includes receiving an Identification-index (I-index) and a physical cell Identifier (ID) used to generate of Inter Working Signal (IWS) contents from a macro BS. The IWS contents is generated by using the physical cell ID. The method includes performing scrambling on the IWS contents by using one of scrambling codes included in a scrambling code set of the macro BS. Thereafter, the IWS contents are transmitted.

### CROSS-REFERENCE TO RELATED APPLICATION(S) AND CLAIM OF PRIORITY

This application claims the benefit under 35 U.S.C. §119(a) of a Korean patent application filed in the Korean Intellectual Property Office on Feb. 13, 2009 and assigned Serial No. 10-2009-0011831, the entire disclosure of which is hereby incorporated by reference.

### TECHNICAL FIELD OF THE INVENTION

The present invention relates to an apparatus and method for supporting a femto Base Station (BS) in a wireless communication system. More particularly, the present invention relates to an apparatus and method for utilizing a reference signal for recognizing a femto BS in a wireless communication system in which a macro BS coexists with the femto BS.

### BACKGROUND OF THE INVENTION

Today, many wireless communication techniques are being proposed to achieve a high-speed mobile communication. Among them, an Orthogonal Frequency Division Multiplexing (OFDM) scheme is accepted as one of the most promising techniques for a next generation wireless communication. The OFDM scheme is expected to be widely used in the a future wireless communication technique, and is currently used as a standard in the Institute of Electrical and Electronics Engineers (IEEE) 802.16-based Wireless Metropolitan Area Network (WMAN) known as the 3.5 generation technology.

The OFDM scheme uses multi-carriers to transmit data. That is, the OFDM scheme is one type of Multi Carrier Modulation (MCM) schemes in which a serially input symbol stream is converted into parallel symbols and the parallel symbols are transmitted by being modulated into a plurality of orthogonal sub-carriers, that is, a plurality of sub-channels.

In case of a cellular-type wireless communication system, a channel state deteriorates due to a geographical factor in a cell or a distance between a Mobile Station (MS) and a Base Station (BS) or movement of the MS, and thus communication between the MS and the BS may not be smoothly performed. For example, even inside a service area of the BS, a propagation shadow area is formed by closed buildings such as offices or homes. If the MS is located in the propagation shadow area, the BS may not be able to perform smooth communication due to a poor channel state between the BS and the MS.

Accordingly, the wireless communication system may provide a femto cell service to provide a high-speed data service while solving a service problem occurring in the propagation shadow area. The femto cell is a small cell area formed by a small-sized BS which accesses to a mobile communication core network through a broadband network installed in an indoor environment such as offices or homes. The small-sized BS is a BS with a small output and directly installed by a user, and can also be referred to as a micro BS, a self configurable BS, a compact BS, an indoor BS, a home BS, a femto BS, and so forth. Hereinafter, the small-sized BS will be referred to as a femto BS.

Meanwhile, when the MS enters the coverage of another neighbor BS from a serving BS from which the MS receives a service, a handover is performed for seamless service provision. In this example, the MS reselects a newly entering BS. According to the conventional handover method, in case if an IEEE 802.16e system, the MS receives a neighbor BS list from the serving BS, and determines a handover target BS by searching neighbor BSs by the use of the neighbor BS list. A 3rd Generation Partnership Project (3GPP) Long Term Evolution (LTE) system considers a method for selecting the handover target BS by scanning all preambles without a separate neighbor BS list.

FIG. 1 illustrates an environment where only a macro cell exists. FIG. 2 illustrates an environment where a macro call and a femto cell coexist.

Comparing FIG. 1 and FIG. 2, in an example of an environment where a macro BS and a femto BS coexist, the number of neighbor BSs is increased more rapidly than an environment where only a typical macro BS exists. Therefore, broadcasting of a neighbor BS list to many femto BSs may cause an overhead of using excessive radio resources. Meanwhile, if an MS performs full search on all other Frequency Allocations (FAs) without using the neighbor BS list, a large computational amount is required, and data transmission is delayed in a process of searching other FAs and thus it is difficult to provide a real-time service.

Since the femto BS is generally installed inside homes or offices, low power consumption is required. Further, since the femto BS is installed by a user at an arbitrary position, mutual interference may occur between neighbor femto BSs. Furthermore, since the femto BS provides a service to a user in an indoor environment, provision of the service may be unnecessary according to whether the user is in the indoor environment or not, and such a case may frequently occur. For this reason, the femto BS requires an autonomous turn on/off function (or a power-saving function) to achieve a low-power mode and to decrease interference between femto BSs.

In order for the femto BS to autonomously switch from a turn-off state to a turn-on state, the MS transmits a signal capable of sensing existence of the femto BS not only in a turn-on mode but also in a turn-off mode, and the MS senses a signal transmitted by the femto BS. However, when femto BSs use different FAs, the same problem as in the handover occurs in order for the MS to search all FAs. That is, a large computation amount is required when the MS searches all FAs without the neighbor BS list, and a real-time service may be difficult due to data transmission delay which occurs in a process of searching other FAs.

### SUMMARY OF THE INVENTION

To address the above-discussed deficiencies of the prior art, it is a primary aspect of the present invention to provide an apparatus and method for supporting a femto cell in a wireless communication system.

Another aspect of the present invention is to provide an apparatus and method for effectively recognizing a femto Base Station (BS) by a Mobile Station (MS) in a wireless communication system in which a macro cell and a femto cell coexist.

Another aspect of the present invention is to provide an apparatus and method for supporting a handover between a macro cell and a femto cell in a wireless communication system in which the macro cell and the femto cell coexist.

Another aspect of the present invention is to provide an apparatus and method for supporting a power-saving mode of a femto BS in a wireless communication system in which a macro cell and a femto cell coexist.

Another aspect of the present invention is to provide an apparatus and method for utilizing a reference signal for recognizing a femto BS in a wireless communication system in which a macro cell and a femto cell coexist.

Another aspect of the present invention is to provide an apparatus and method for reducing an overhead caused by utilization of a reference signal for recognizing a femto BS in a wireless communication system in which a macro cell and a femto cell coexist.

In accordance with an aspect of the present invention, a method for operating a femto BS in a wireless communication system in which a macro cell and a femto cell coexist is provided. The method includes receiving an Identification-index (I-index) and a physical cell Identifier (ID) used to generate of Inter Working Signal (IWS) contents from a macro BS, generating the IWS contents by using the physical cell ID, performing scrambling on the IWS contents by using one of scrambling codes included in a scrambling code set of the macro BS, and transmitting the IWS contents.

In accordance with another aspect of the present invention, a method for operating an MS in a wireless communication system in which a macro cell and a femto cell coexist is provided. The method includes receiving IWS contents of a femto BS by performing blind decoding using scrambling codes included in a scrambling code set of a macro BS, and determining at least one of an operation Frequency Allocation (FA), physical cell ID, I-index, and power-saving mode indicator of the femto BS by using at least one of the IWS contents and a scrambling code index used in the decoding of the IWS contents.

In accordance with another aspect of the present invention, a femto BS apparatus in a wireless communication system in which a macro cell and a femto cell coexist is provided. The apparatus includes an interface that receives an I-index and a physical cell ID used to generate of IWS contents from a macro BS, a generator for generating the IWS contents by using the physical cell ID, a encoder that performs scrambling on the IWS contents by using one of scrambling codes included in a scrambling code set of the macro BS, and a transmitter that transmits the IWS contents.

In accordance with another aspect of the present invention, an MS apparatus in a wireless communication system in which a macro cell and a femto cell coexist is provided. The apparatus includes a decoder that receives IWS contents of a femto BS by performing blind decoding using scrambling codes included in a scrambling code set of a macro BS, and an analyzer that determines at least one of an operation FA, physical cell ID, I-index, and power-saving mode indicator of the femto BS by using at least one of the IWS contents and a scrambling code index used in the decoding of the IWS contents.

In accordance with another aspect of the present invention, a method for transmitting an IWS for allowing an MS to recognize existence of a femto BS in a wireless communication system in which a macro cell and a femto cell coexist is provided. The method includes assigning, by a macro BS, a unique femto BS ID and a physical cell ID to the femto BS, generating, by the femto BS, IWS contents including at least one of the unique femto BS ID, the physical cell ID, a power-saving mode indicator, and a block code, and transmitting, by the femto BS, the IWS content, wherein the unique femto BS ID consists of a combination of bits for indicating the femto BS and bits for identifying the macro BS.

In accordance with another aspect of the present invention, a method for transmitting an IWS for allowing an MS to recognize existence of a femto BS in a wireless communication system in which a macro cell and a femto cell coexist is provided. The method includes transmitting, by a macro BS, a scrambling code set index and a physical cell ID and I-index of the femto BS to the femto BS, generating, by the femto BS, IWS contents including the physical cell ID and the I-index, performing, by the femto BS, scrambling on the IWS contents by using one of scrambling codes included in the scrambling code set index, and transmitting, by the femto BS, the IWS contents.

In accordance with another aspect of the present invention, a method for transmitting an IWS for allowing an MS to recognize existence of a femto BS in a wireless communication system in which a macro cell and a femto cell coexist is provided. The method includes transmitting, by a macro BS, a scrambling code set index and a physical cell ID and I-index of the femto BS to the femto BS, generating, by the femto BS, the IWS contents including a first bit-stream consisting of some bits of the physical cell ID, a power-saving mode indicator, and a block code, performing, by the femto BS, scrambling on the IWS contents by using a scrambling code having the same index as a combination of a second bit-stream consisting of the remaining bits of the physical cell ID other than the first bit-stream, and the I-index among scrambling codes included in the scrambling code set index, and transmitting, by the femto BS, the IWS contents.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an environment where only a macro cell exists;

FIG. 2 illustrates an environment where a macro call and a femto cell coexist;

FIG. 3 illustrates a concept of utilizing an Inter Working Signal (IWS) according to an embodiment of the present invention;

FIG. 4 illustrates a configuration of IWS information according to an embodiment of the present invention;

FIG. 5 illustrates a configuration for a short femto Base Station (BS) IDentifier (ID) according to an embodiment of the present invention;

FIG. 6 illustrates an example of assigning a scrambling code set index in a hexagonal cell structure;

FIG. 7 illustrates another configuration of IWS contents according to an embodiment of the present invention;

FIG. 8 illustrates a structure of a femto BS in a wireless communication system according to an embodiment of the present invention;

FIG. 9 illustrates a structure of a Mobile Station (MS) in a wireless communication system in which a macro cell and a femto cell coexist according to an exemplary embodiment of the present invention;

FIG. 10 illustrates an operation of a macro BS in a wireless communication system according to an exemplary embodiment of the present invention;

FIG. 11 illustrates an operation of a femto BS in a wireless communication system according to an exemplary embodiment of the present invention; and

FIG. 12 illustrates an operation of an MS in a wireless communication system according to an exemplary embodiment of the present invention.

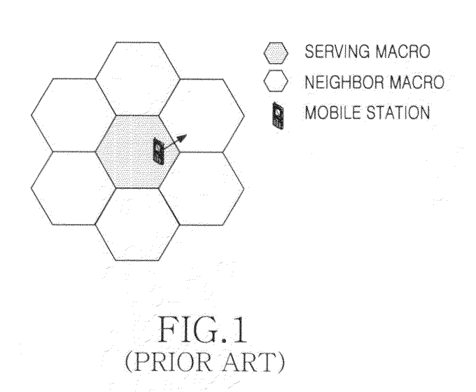

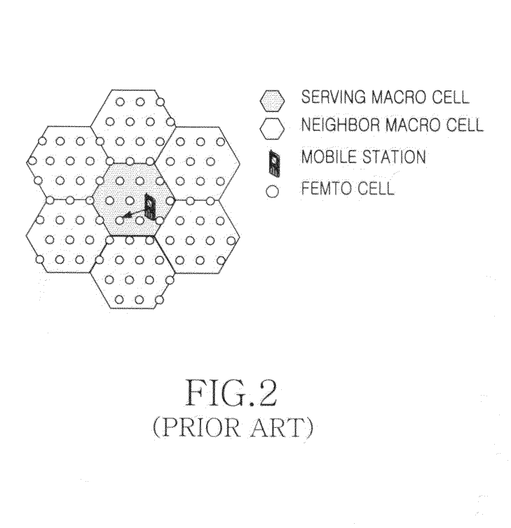

### DETAILED DESCRIPTION OF THE INVENTION

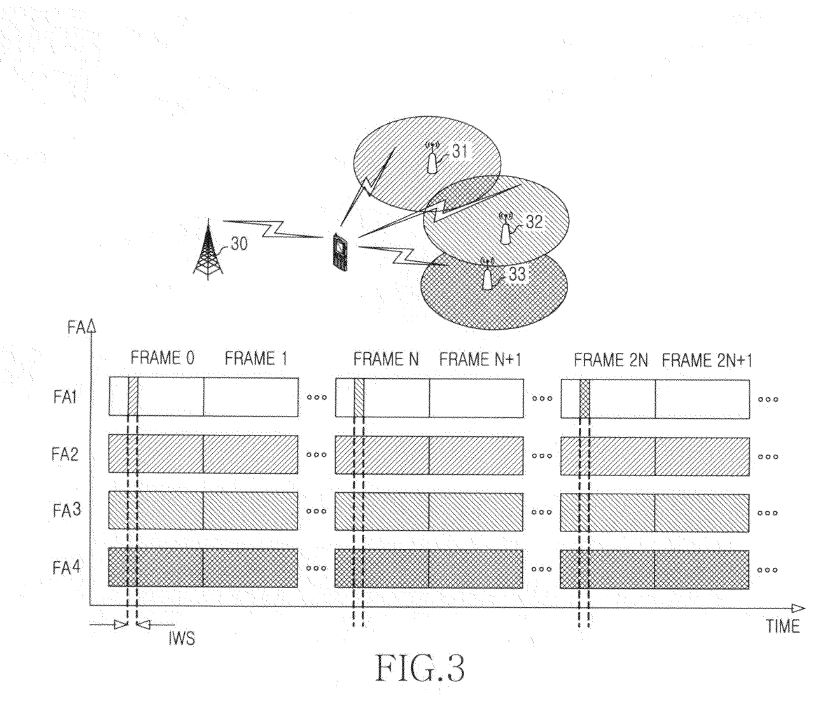

FIGS. 3 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system.

The present invention provides a method for utilizing a reference signal for recognizing a femto Base Station (BS) in a wireless communication system in which a macro cell and a femto cell coexist.

Hereinafter, the wireless communication system is a communication system using, for example, an Orthogonal Frequency Division Multiplexing (OFDM) scheme or an Orthogonal Frequency Division Multiple Access (OFDMA) scheme. Although a broadband wireless access communication system using multi-carriers is described hereinafter for example, the present invention can equally apply to another wireless communication system in which a small-sized BS, i.e., a femto BS, is installed.

A reference signal for the femto BS proposed in the present invention may be referred to as other terms. For convenience of explanation, the reference signal will be referred to as an Inter Working Signal (IWS) in the present invention.

FIG. 3 illustrates a concept of utilizing an IWS according to an embodiment of the present invention.

Referring to FIG. 3, a macro BS 30 performs communication using a Frequency Allocation (FA)1, and femto BSs 31 to 33 belonging to the macro BS 30 perform communication by using one of an FA2 to an FAn other than the FA1. In this case, it is assumed that all BSs are synchronized. The macro BS 30 allocates resources in the FA1 for an IWS transmitted by the femto BSs 31 to 33, and does not transmit a signal for time/frequency resources allocated for the IWS. Each of the femto BSs 31 to 33 transmits the IWS by using resources allocated in the FA1. An MS that receives a service from the macro BS 30 receives the IWS of each of the femto BSs 31 to 33 in the FA1, which is an operation FA of the macro BS 30.

If all FAs are simultaneously used by a macro cell and a femto cell, the macro BS 30 may not transmit a signal for a defined time/frequency resource of each operation FA, and the femto BSs 31 to 33 may transmit the IWS by using a defined resource in each FA.

In another embodiment, the femto BSs 31 to 33 may transmit the IWS by using a time/frequency resource commonly allocated irrespective of an operation FA of the femto cell over an operation FA of the macro BS 30.

In another embodiment, when the macro BS 30 and the femto BSs 31 to 33 operate at a frequency reuse 1, that is, when the macro BS 30 and the femto BSs 31 to 33 operate by using the same FA, the femto BSs 31 to 33 may transmit the IWS in the operation FA without band switching.

A method for transmitting/receiving an IWS according to the present invention will be described. Hereinafter, an Institute of Electrical and Electronics Engineers (IEEE) 802.16m-based system will be described for example. However, the IEEE 802.16m-based system is for exemplary purposes only to facilitate understanding of the present invention, and thus the present invention can also easily apply to a communication system based on another standard.

Information transmitted using the IWS (hereinafter, such information is referred to as “IWS contents”) may include an operation FA, a physical cell ID, a unique femto BS IDentifier (ID), a power-saving mode indicator (also referred to as a turn on/off indicator), or the like of a femto BS which transmits the IWS.

The unique femto BS ID is necessary to determine whether the MS can access to a corresponding femto BS, and may be used as an identifier for a target femto BS when a hand-in (or a handover) is performed on the femto BS or when the femto BS is requested to wake up. Meanwhile, the operation FA and the physical cell ID may be used when the MS scans neighbor femto BSs. The power-saving mode indicator may be used to determine whether a corresponding femto BS is in a power-saving state.

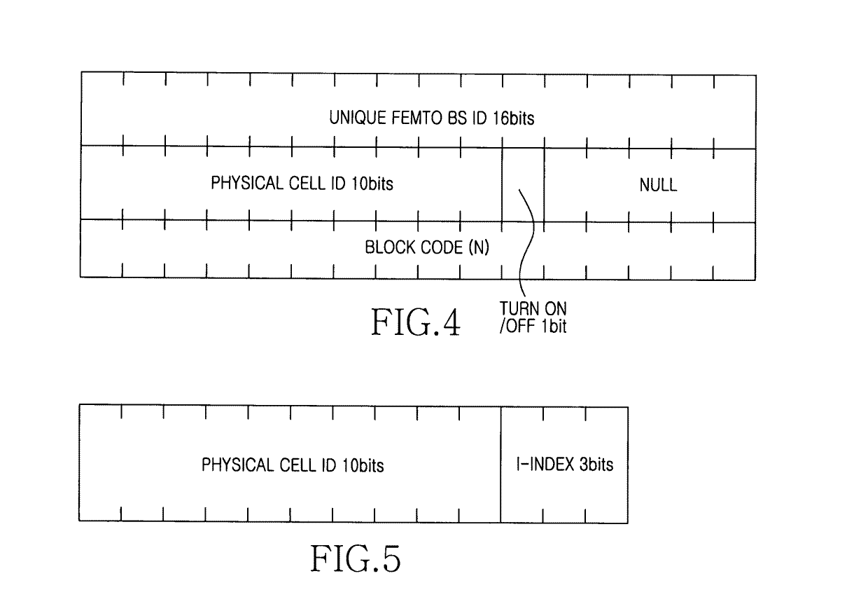

FIG. 4 illustrates a configuration of IWS information according to an exemplary embodiment of the present invention.

It is assumed in FIG. 4 that the number of physical cell IDs assigned to a femto BS is about ‘700 ’ to ‘1000 ’, and the number of installable femto cells per macro cell is up to ‘8000 ’. In this case, the number of information bits required for IWS contents is at least twenty-seven bits except for a block code for error detection/correction such as cyclic redundancy check (CRC). More specifically, sixteen bits are required for a unique femto BS ID, ten bits are required for the physical cell ID, and one bit is required for a power-saving indicator (or a turn on/off indicator). Therefore, at least twenty-seven bits are required.

Herein, by the use of the unique femto BS, the MS and the macro BS have to be able to identify a femto BS in the macro cell without ambiguity. Meanwhile, the MS has to be able to distinguish whether a femto BS which transmits the IWS belongs to a serving macro BS of the MS or to another macro BS. Therefore, the 16-bit unique femto BS ID may be configured with a combination of a 13-bit indicator for indicating a femto BS inside the coverage of a super-ordinate macro BS to which the femto BS belongs and a 3-bit macro BS index for identifying the macro BS. The macro BS index may be assigned to have a uniqueness in a 2-tier range in a hexagonal cell model by applying a 7-cell reuse pattern.

Since the IWS is transmitted using radio resources, it is important to decrease an overhead. Hereinafter, another configuration of IWS contents for decreasing the overhead will be described.

FIG. 5 illustrates a configuration for a short femto BS ID according to an exemplary embodiment of the present invention.

Referring to FIG. 5, the short femto BS ID is configured with a combination of a 10-bit physical cell ID and a 3-bit Identification-index (I-index). The physical cell ID is assigned when reuse is allowed to the femto BS by a macro BS or a network manager in an initial configuration or reconfiguration process. The I-index is assigned uniquely to femto BSs using the same physical cell ID in a macro cell by a super-ordinate macro BS to which the femto BS belongs. Therefore, a short femto BS ID has a uniqueness in the super-ordinate macro BS to which the femto BS belongs. A method for assigning the I-index to the femto BS by the macro BS will be described later in detail with reference to the accompanying drawings. As such, when the physical cell ID is transmitted by being included in the short femto BS ID, the IWS contents can be shortened to 13 bits.

When utilizing the short femto BS ID, the macro BS has to manage each femto BS in a cell by mapping a global unique BS ID and the short femto BS ID. That is, the macro BS manages a mapping table as shown in Table 1 below, and updates the mapping table when the physical cell ID and the I-index are modified due to changes in a surrounding communication environment of the femto BS. For example, the global unique BS ID may be a BS ID having a uniqueness in a network, for example, a 48-bit full BS ID of the IEEE 802.16e system.

TABLE 1

| Global unique BS ID | Short femto BS ID |
|---|---|
| 0x123456 | 0b1110101010101 |
| 0x123abc | 0b1110010101010 |
| . . . | . . . |
| 0x987654 | 0b1101010111101 |

Meanwhile, when information configured as shown in FIG. 5 is transmitted by using an IWS, an MS cannot distinguish whether a femto BS which transmits the IWS belongs to a serving macro BS or a neighbor macro BS. Therefore, the present invention proposes a method for distinguishing a macro BS by using a code scrambled in IWS contents.

The present invention proposes 7×64 scrambling codes for an IWS. That is, as shown in Table 2 below, scrambling codes available in a system are grouped into 7 groups, and an index is assigned to each group and each code.

TABLE 2

| | | Scrambling code index | | | | |
|---|---|---|---|---|---|---|
| code | #1 | 0 | 1 | 2 | . . . | 63 |
| group | #2 | 0 | 1 | 2 | . . . | 63 |
| index | #3 | 0 | 1 | 2 | . . . | 63 |
| | #4 | 0 | 1 | 2 | . . . | 63 |
| | #5 | 0 | 1 | 2 | . . . | 63 |
| | #6 | 0 | 1 | 2 | . . . | 63 |
| | #7 | 0 | 1 | 2 | . . . | 63 |

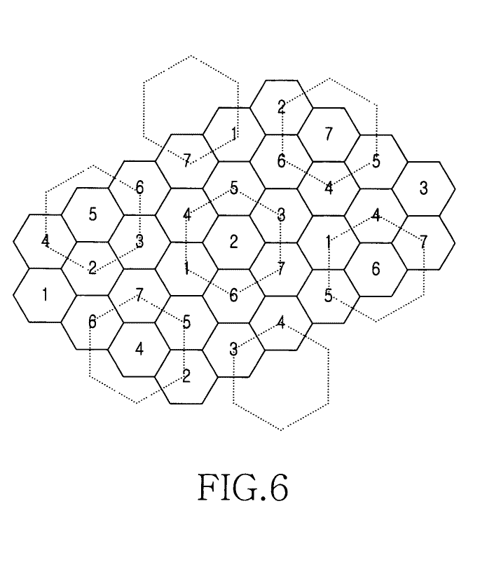

FIG. 6 illustrates an example of assigning a scrambling code set index in a hexagonal cell structure.

As shown in FIG. 6, the scrambling code set index is assigned to each macro BS by using a 7-cell reuse pattern. When seven indices are reused in assignment by using the 7-cell reuse pattern, the same index appears on a 3-tier.

A femto BS may select one code belonging to a scrambling code set assigned to a super-ordinate macro BS, or may scramble and transmit IWS contents by using a code assigned by the super-ordinate macro BS. An MS performs decoding on the received IWS by using codes of the scrambling code set assigned to a serving macro BS. In this case, the MS can decode only the IWS transmitted by the femto BS belonging to the serving macro BS; and thus, the MS can determine whether the femto BS belongs to the serving macro BS without an additional identifier. That is, it is possible to indicate the femto BS without ambiguity by using a 13-bit short femto BS ID. In addition, although the 7×64 scrambling codes are used in the system as described above, the number of scrambling codes used by the MS to perform blind decoding on the IWS is 64, and thus the MS can decode the IWS with decreased complexity.

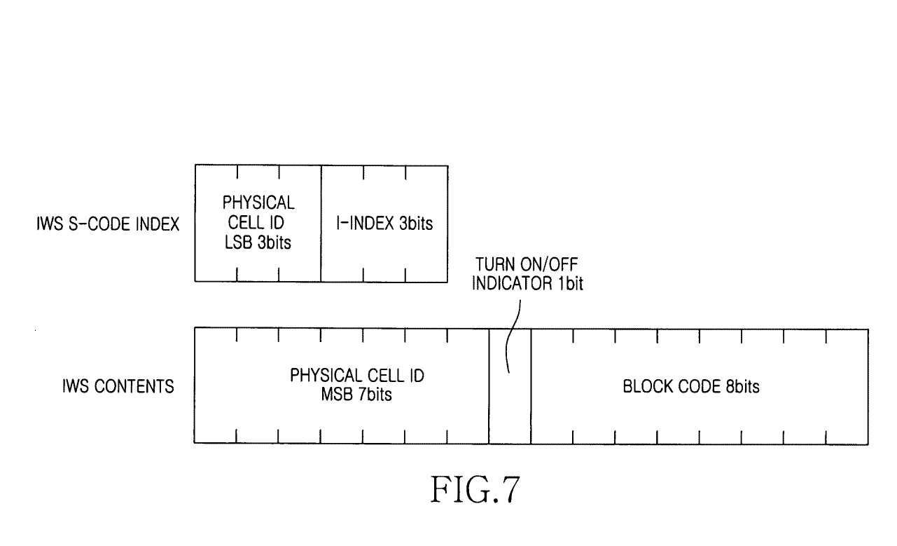

FIG. 7 illustrates another configuration of IWS contents according to an embodiment of the present invention.

Referring to FIG. 7, information bits of the IWS contents are sixteen bits. That is, the IWS contents may include Most Significant Bit (MSB) seven bits of a physical cell ID, one bit of a power-saving indicator (or a turn on/off indicator), and eight bits of a block code. The block code may be an 8×8 block code of which a data bit consists of MSB eight bits of the IWS contents or a 14×8 block code of which a data bit consists of the MSB eight bits of the IWS contents and six bits of a scrambling code index. In this case, Least Significant Bit (LSB) three bits of the physical call ID and three bits of an I-index are not included in the IWS contents, and the LSB 3 bits of the physical cell ID and the three bits of the I-index are delivered by using the scrambling code.

The IWS contents are scrambled by using the scrambling code. The scrambling code index is determined by a combination of the LSB three bits of the physical cell ID and the three bits of the I-index. Therefore, an MS evaluates an index of a scrambling code which is successfully descrambled, and thus obtains the LSB three bits of the physical cell ID and the three bits of the I-index.

Accordingly, by using the 16-bit IWS contents, a femto BS may transmit a 10-bit physical cell ID, a short femto BS ID consisting of a 3-bit I-index, a 1-bit power-saving mode indicator, and a 8-bit block code. The femto BS transmits the IWS contents by scrambling the IWS contents by the use of the scrambling code index (i.e., LSB three bits of the physical cell ID+three bits of the I-index) from the IWS scrambling code set of a super-ordinate macro BS. Meanwhile, the macro BS considers the following aspects when assigning the I-index to a sub-ordinate femto BS.

First, the short femto BS ID is not be duplicated in the macro cell. Second, the IWS scrambling code index of the femto BS does not overlap with the IWS scrambling code of a neighbor femto BS.

Based on the aforementioned description, exemplary embodiments of the present invention will be described in detail.

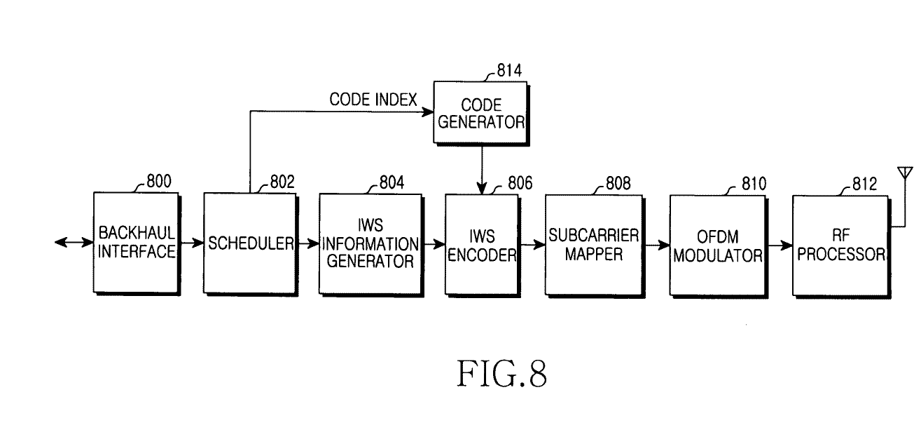

FIG. 8 illustrates a structure of a femto BS in a wireless communication system according to an embodiment of the present invention.

The femto BS of FIG. 8 is illustrated by focusing on an IWS transmitter, and includes a backhaul interface 800, a scheduler 802, an IWS information generator 804, an IWS encoder 806, a subcarrier mapper 808, an OFDM modulator 810, a Radio Frequency (RF) processor 812, and a code generator 814. It is assumed that the femto BS supports multiple FAs.

The backhaul interface 800 provides an interface for communication with another macro BS, another femto BS, and a network manager through a backhaul or a backbone network. That is, the backhaul interface 800 analyzes a backhaul message received from other BSs, and performs a function of generating and transmitting a transmission backhaul message.

The scheduler 802 receives from a super-ordinate macro BS a physical cell ID and an IWS scrambling code set index assigned to the macro BS, and controls such that neighbor femto BSs are monitored based on the IWS scrambling code set. Further, according to the monitoring result, the scheduler 802 generates an unavailable scrambling code index list or an available scrambling code index list and reports the generated list to the macro BS. Thereafter, the scheduler 802 receives a short femto BS ID from the macro BS, and determines a scrambling code for an IWS on the basis of the short femto BS ID.

The scheduler 802 performs resource scheduling for frame communication. According to the present invention, the scheduler 802 performs scheduling for IWS transmission on the basis of IWS configuration information received from the macro BS and an operation FA of the femto BS. For example, for each FA, the IWS configuration information may include a transmission start point of the IWS, a transmission period, an IWS duration position in a frame, and the like. Further, the scheduler 802 performs overall control operations in addition to resource scheduling.

The IWS information generator 804 generates IWS contents. For example, the IWS contents have a configuration as illustrated in FIG. 4, FIG. 6, or FIG. 7. That is, the IWS contents may include a part of a bit-stream of the physical cell ID, a power-saving mode indicator, and a block code for error detection/correction (such as a CRC code).

The code generator 814 generates an IWS scrambling code corresponding to a code index provided from the scheduler 802. The IWS scrambling code is a code belonging to a scrambling code set assigned to the macro BS. The IWS encoder 806 codes or scrambles the IWS contents provided from the IWS information generator 804 by using the scrambling code provided from the code generator 814. For one example, the IWS encoder 806 may spread-modulate the IWS contents by using the scrambling code. For another example, the IWS encoder 806 may code and modulate the IWS contents, and may mask the modulated data to the scrambling code. As such, an encoding operation of the IWS encoder 806 may be performed in various manners.

The subcarrier mapper 808 maps the IWS provided from the IWS encoder 806 to a predetermined resource. For example, according to the IWS configuration information, the IWS may be mapped to a specific frame in a specific super frame, a specific subframe in the specific frame, and a specific OFDM symbol duration in the specific subframe.

The OFDM modulator 810 performs OFDM-modulation on a signal stream including the IWS provided from the subcarrier mapper 808 to generate time-domain sample data. The RF processor 812 converts the sample data provided from the OFDM modulator 810 into an analog signal, converts the analog signal into an RF signal by using a carrier, and then transmits the converted signal through an antenna. Herein, if a different carrier is used for each FA, the RF processor 812 may transition from an operation FA of the femto BS to an operation FA of the macro BS during a specific subframe, and may transmit the IWS by using the operation FA of the macro BS during an IWS duration of the specific subframe.

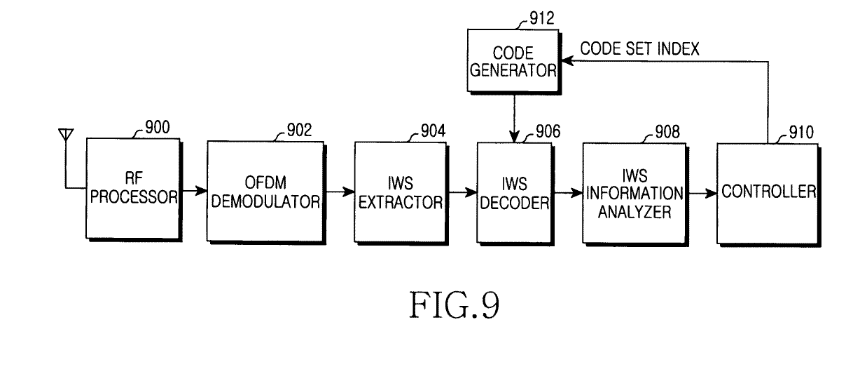

FIG. 9 illustrates a structure of an MS in a wireless communication system in which a macro cell and a femto cell coexist according to an exemplary embodiment of the present invention.

The MS of FIG. 9 is illustrated by focusing on an IWS receiver, and includes an RF processor 900, an OFDM demodulator 902, an IWS extractor 904, an IWS decoder 906, an IWS information analyzer 908, a controller 910, and a code generator 912. It is assumed that the MS supports multiple FAs. Herein, if a Fast Fourier Transform (FFT) operator included in the OFDM demodulator 902 covers a full band of the multiple FAs, the RF processor 900 may use one carrier. Otherwise, if a separate carrier is used for each FA, the RF processor 900 may perform an FA transition operation.

The RF processor 900 converts a received RF signal into a baseband signal by using a carrier, and converts the baseband signal into digital sample data. The OFDM demodulator 902 performs OFDM-demodulation on the sample data provided from the RF processor 900 to output frequency-domain data. Herein, OFDM demodulation includes Cyclic Prefix (CP) removal, an FFT operation, etc.

According to IWS configuration information, the IWS extractor 904 extracts an IWS from the frequency-domain data provided from the OFDM demodulator 902.

The controller 910 controls an IWS reception operation by using the IWS configuration information and an IWS scrambling code set index received from a serving macro BS. The code generator 912 generates codes of the IWS scrambling code set according to the IWS scrambling code set index provided from the controller 910, and outputs the generated codes to the IWS decoder 906.

The IWS decoder 906 performs decoding (i.e., blind decoding) on the IWS provided from the IWS extractor 904 by using scrambling codes of the scrambling code set provided from the code generator 912. If decoding is successful in this case, the IWS decoder 906 provides the scrambling code index and the decoding data (i.e., IWS contents) to the IWS information analyzer 908.

The IWS information analyzer 908 determines an operation FA, a physical cell ID, a short femto BS ID, a power-saving state, or the like of the femto BS in association with the received IWS by using the IWS contents and the scrambling code index provided from the IWS decoder 906, and provides the determination result to the controller 910.

Then, the controller 910 may perform a corresponding operation by using information provided from the IWS information analyzer 908. For example, if the IWS transmitted by the femto BS is captured during communication with the macro BS, the controller 910 may request the macro BS to scan neighbor femto BSs. Then, a scan duration may be assigned to scan the neighbor femto BSs. If the scanning result shows that the femto BS which is currently operating in a power-saving mode needs to wake up, the controller 910 may be assigned with the scan duration by the macro BS to allow the femto BS to transition to an operation mode by attempting ranging to the femto BS during the scan duration.

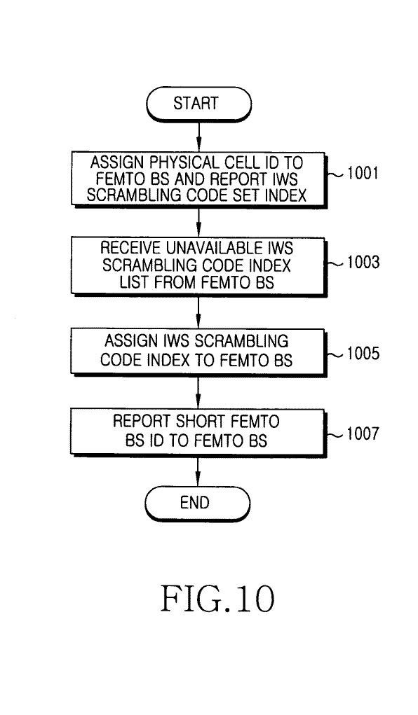

FIG. 10 illustrates an operation of a macro BS in a wireless communication system according to an exemplary embodiment of the present invention.

Referring to FIG. 10, when a femto BS is installed inside an area of the macro BS, in step 1001, the macro BS assigns a physical cell ID to the femto BS, and reports the physical cell ID and an IWS scrambling code set index assigned to the macro BS to the femto BS. Herein, assigning of the physical cell ID to the femto BS may be performed by the macro BS or a network manager. For example, when the femto BS performs a self-configuration operation in an initial configuration or reconfiguration process, a result obtained by scanning neighbor BSs may be delivered to the macro BS or the network manager, and the macro BS or the network manager may assign the physical cell ID to the femto BS by using the scanning result.

In step 1003, the macro BS receives an unavailable IWS scrambling code index list or an available IWS scrambling code index list from the femto BS. That is, the femto BS monitors an IWS of neighbor femto BSs by using IWS configuration information and an IWS scrambling code set index received from the macro BS, and reports a list of scrambling codes used by the neighbor femto BSs or an index list of IWS scrambling codes not used by the neighbor femto BS to the macro BS according to the monitoring result.

Upon receiving the unavailable scrambling code index list, in step 1005, the macro BS selects one of codes from the IWS scrambling code set other than codes of the scrambling code index list, and assigns the selected code to the femto BS. In this case, the macro BS assigns an I-index to each of femto BSs using the same physical cell ID in a macro cell so that a short femto BS ID is unique for each femto BS, and then selects a scrambling code corresponding to a code index consisting of a combination of a part of a bit-stream of the physical cell ID (e.g., LSB 3 bits) and the I-index. As such, when the short femto BS ID of the femto BS is determined, the macro BS updates a relation of the short femto BS ID and a global unique BS ID of the femto BS as shown in the mapping table as shown in Table 1 above.

In step 1007, the macro BS reports the determined short femto BS ID to the femto BS. For another example, the macro BS may report the determined I-index or a scrambling code index to the femto BS. In this case, the femto BS may configure the short femto BS ID by combining a pre-known physical cell ID and the I-index.

The procedure of FIG. 10 may be performed by the macro BS by the aid of the self-configuration function of the femto BS, or some steps of the procedure may be replaced with the self-configuration function of the femto BS.

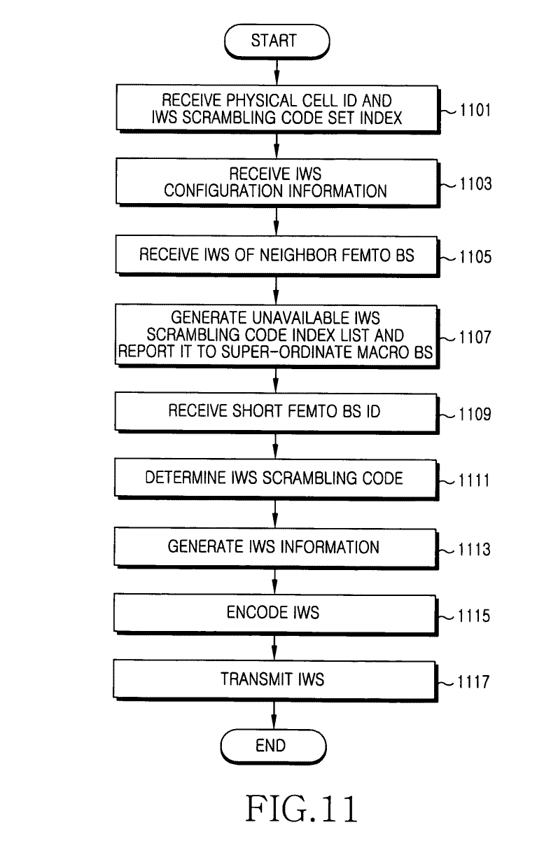

FIG. 11 illustrates an operation of a femto BS in a wireless communication system according to an exemplary embodiment of the present invention.

Referring to FIG. 11, when an initial configuration or reconfiguration process is performed in an installation process, in step 1101, the femto BS is assigned with a physical cell ID by a super-ordinate macro BS or a network manager, and receives an IWS scrambling code set index of the macro BS.

In step 1103, the femto BS receives IWS configuration information. For each FA, the IWS configuration information may include a transmission start point of the IWS, a transmission period, an IWS duration position in a frame, and the like. The physical cell ID, the IWS scrambling code set index, and the IWS configuration information may be received by using the same message or different messages.

Upon receiving the IWS configuration information, in step 1105, the femto BS monitors an IWS of neighbor femto BS by using the IWS configuration information and the IWS scrambling code set index of the macro BS, and determines a list of codes used by the neighbor femto BSs or an index list of IWS scrambling codes not used by the neighbor femto BS according to the monitoring result.

In step 1107, the femto BS transmits the determined unavailable IWS scrambling code index list to the macro BS. In step 1109, the femto BS receives a short femto BS ID from the macro BS. Instead of the short femto BS ID, an I-index or a scrambling code index may be received.

Upon completion of the initial configuration or reconfiguration, in step 1111, the femto BS extracts the I-index from the short femto BS ID, and determines a scrambling code index by combining some bits (such as, LSB three bits) of the pre-assigned physical cell ID and the I-index. Further, by using the scrambling code set index of the macro BS and the scrambling code index, the femto BS determines an IWS scrambling code to be used for IWS transmission.

When an IWS transmission time arrives according to the IWS configuration information, the femto BS generates IWS contents in step 1113. The IWS contents may include some bits (such as MSB seven bits) of the physical cell ID, a power-saving mode indicator (or a turn on/off indicator), and a block code for error detection/correction (e.g., CRC code).

In step 1115, the femto BS encodes or scrambles the IWS contents by using the IWS scrambling code. For one example, the femto BS may perform encoding and modulation on the IWS contents, and may mask the modulated data to the scrambling code. For another example, the IWS contents may be spread-modulated by using the IWS scrambling code.

In step 1117, the femto BS transmits the scrambled IWS by using an operation FA of the macro BS.

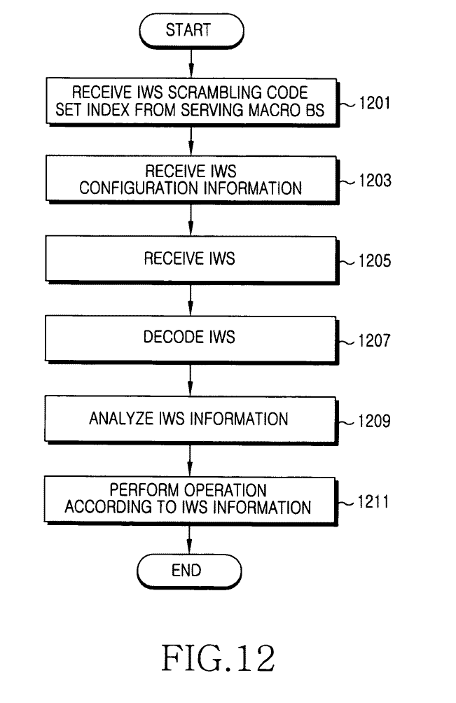

FIG. 12 illustrates an operation of an MS in a wireless communication system according to an exemplary embodiment of the present invention.

Referring to FIG. 12, in step 1201, the MS receives, from a serving macro BS, IWS configuration information and an IWS scrambling code set index assigned to the serving macro BS. The IWS configuration information and the IWS scrambling code set index may be included in a Broadcast Channel (BCH) message transmitted by the macro BS.

The MS receives the IWS configuration information in step 1203, and receives an IWS according to the IWS configuration information in step 1205. In step 1207, by using scrambling codes corresponding to the IWS scrambling code set index, the MS performs blind decoding on the received IWS. In this case, the MS determines a scrambling code index corresponding to IWS contents, of which decoding is successful.

In step 1209, by using the determined scrambling code index and the IWS contents obtained by performing decoding, the MS determines an operation FA, a physical cell ID, a short femto BS ID, a power-saving state, or the like of the femto BS in association with the received IWS.

In step 1211, the MS performs a corresponding operation by using information obtained from the received IWS. For example, by using information of the IWS contents, the MS may perform an operation such as a hand-in or handover to the femto BS, a wakeup request of the femto BS, and so forth.

According to embodiments of the present invention, a femto BS transmits a reference signal by using an operation FA of a macro BS in a wireless communication system in which a macro cell and a femto cell coexist transmits. Therefore, there is an advantage in that an MS which is currently communicating with the macro BS can capture a signal of the femto BS without FA modification. In addition, embodiments of the present invention can remove resource waist caused by a neighbor BS list since the neighbor BS list for femto cells is not necessary. In addition, embodiments of the present invention provide an advantage in that a femto BS operating in a power-saving mode can be recognized by the MS without changing an operation FA. In addition, embodiments of the present invention decrease an overhead caused by reference signal transmission and simplifies an operation of utilizing a reference signal, thereby increasing system efficiency.

What is claimed is:

1. A method for operating a femto Base Station (BS) in a wireless communication system in which a macro cell and a femto cell coexist, the method comprising:
receiving an Identification-index (I-index) and a physical cell Identifier (ID) used to generate of Inter Working Signal (IWS) contents from a macro BS;
generating the IWS contents by using the physical cell ID;
performing scrambling on the IWS contents by using one of scrambling codes included in a scrambling code set of the macro BS; and
transmitting the IWS contents.

2. The method of claim 1, wherein the generating of the IWS contents comprises generating the IWS contents comprising at least one of the physical cell ID and the I-index.

3. The method of claim 1, wherein the generating of the IWS contents comprises generating the IWS contents comprising at least one of a first bit-stream consisting of some bits of the physical cell ID, a power-saving mode indicator, and a block code.

4. The method of claim 3, wherein scrambling is performed on the IWS contents by using a scrambling code having the same index as a combination of a second bit-stream consisting of the remaining bits of the physical cell ID other than the first bit-stream, and the I-index.

5. The method of claim 1, further comprising:
receiving the scrambling code set index from the macro BS;
monitoring an IWS of at least one neighbor femto BS by using scrambling codes included in the scrambling code set;
generating an unavailable code index list or an available code index list in the scrambling code set according to the monitoring result; and
reporting the unavailable code index list or the available code index list to the macro BS.

6. The method of claim 1,
wherein the number of scrambling code sets supportable by the system is 7,
wherein each scrambling code set comprises 64 scrambling codes, and
wherein a scrambling code set index is assigned to each macro BS according to a 7-cell reuse pattern.

7. A method for operating a Mobile Station (MS) in a wireless communication system in which a macro cell and a femto cell coexist, the method comprising:
receiving Inter Working Signal (IWS) contents of a femto Base Station (BS) by performing blind decoding using scrambling codes included in a scrambling code set of a macro BS; and
determining at least one of an operation Frequency Allocation (FA), physical cell Identifier (ID), Identification-index (I-index), and power-saving mode indicator of the femto BS by using at least one of the IWS contents and a scrambling code index used in the decoding of the IWS contents.

8. The method of claim 7, wherein the IWS contents comprise at least one of the physical cell ID and I-index of the femto BS.

9. The method of claim 7, wherein the IWS contents comprise at least one of a first bit-stream consisting of some bits of the physical cell ID, the power-saving mode indicator, and a block code.

10. The method of claim 9, wherein the determining of the physical cell ID of the femto BS by using at least one of the IWS contents and the scrambling code index used in the decoding of the IWS contents comprises determining a bit-stream obtained by combining the first bit-stream included in the IWS contents and some bits of the scrambling code index as the physical cell ID.

11. The method of claim 7,
wherein the number of scrambling code sets supportable by the system is 7,
wherein each scrambling code set comprises 64 scrambling codes, and
wherein a scrambling code set index is assigned to each macro BS according to a 7-cell reuse pattern.

12. A femto Base Station (BS) apparatus in a wireless communication system in which a macro cell and a femto cell coexist, the apparatus comprising:
an interface configured to receive an Identification-index (I-index) and a physical cell Identifier (ID) used to generate of Inter Working Signal (IWS) contents from a macro BS;
a generator configured to generate the IWS contents by using the physical cell ID;
a encoder configured to perform scrambling on the IWS contents by using one of scrambling codes included in a scrambling code set of the macro BS; and
a transmitter configured to transmit the IWS contents.

13. The apparatus of claim 12, wherein the generator generates the IWS contents comprising at least one of the physical cell ID and the I-index.

14. The apparatus of claim 12, wherein the generator is configured to generate the IWS contents comprising at least one of a first bit-stream consisting of some bits of the physical cell ID, a power-saving mode indicator, and a block code.

15. The apparatus of claim 14, wherein the encoder performs scrambling on the IWS contents by using a scrambling code comprising an index that is substantially similar to a combination of a second bit-stream consisting of the remaining bits of the physical cell ID other than the 1^{st} bit-stream, and the I-index.

16. The apparatus of claim 12, wherein the interface is configured to receive the scrambling code set index from the macro BS, monitor an IWS of at least one neighbor femto BS by using scrambling codes included in the scrambling code set, generates an unavailable code index list or an available code index list in the scrambling code set according to the monitoring result, and report the unavailable code index list or the available code index list to the macro BS.

17. The apparatus of claim 12,
wherein the number of scrambling code sets supportable by the system is 7,
wherein each scrambling code set comprises 64 scrambling codes, and
wherein a scrambling code set index is assigned to each macro BS according to a 7-cell reuse pattern.

18. A Mobile Station (MS) apparatus in a wireless communication system in which a macro cell and a femto cell coexist, the apparatus comprising:
a decoder configured to receive Inter Working Signal (IWS) contents of a femto Base Station (BS) by performing blind decoding using scrambling codes included in a scrambling code set of a macro BS; and
an analyzer configured to determine at least one of an operation Frequency Allocation (FA), physical cell IDentifier (ID), Identification-index (I-index), and power-saving mode indicator of the femto BS by using at least one of the IWS contents and a scrambling code index used in the decoding of the IWS contents.

19. The apparatus of claim 18, wherein the IWS contents comprise at least one of the physical cell ID and I-index of the femto BS.

20. The apparatus of claim 18, wherein the IWS contents comprise at least one of a first bit-stream consisting of some bits of the physical cell ID, the power-saving mode indicator, and a block code.

21. The apparatus of claim 20, wherein the analyzer is configured to determine a bit-stream obtained by combining the first bit-stream included in the IWS contents and some bits of the scrambling code index as the physical cell ID.

22. The apparatus of claim 18,
wherein the number of scrambling code sets supportable by the system is 7,
wherein each scrambling code set comprises 64 scrambling codes, and
wherein a scrambling code set index is assigned to each macro BS according to a 7-cell reuse pattern.

23. A method for transmitting an Inter Working Signal (IWS) for allowing a Mobile Station (MS) to recognize existence of a femto Base Station (BS) in a wireless communication system in which a macro cell and a femto cell coexist, the method comprising:
assigning, by a macro BS, a unique femto BS IDentifier (ID) and a physical cell ID to the femto BS;
generating, by the femto BS, IWS contents comprising at least one of the unique femto BS ID, the physical cell ID, a power-saving mode indicator, and a block code; and
transmitting, by the femto BS, the IWS content,
wherein the unique femto BS ID consists of a combination of bits for indicating the femto BS and bits for identifying the macro BS.

24. A method of transmitting an Inter Working Signal (IWS) for allowing a Mobile Station (MS) to recognize existence of a femto Base Station (BS) in a wireless communication system in which a macro cell and a femto cell coexist, the method comprising:
transmitting, by a macro BS, a scrambling code set index and a physical cell IDentifier (ID) and Identification-index (I-index) of the femto BS to the femto BS;
generating, by the femto BS, IWS contents comprising the physical cell ID and the I-index;
performing, by the femto BS, scrambling on the IWS contents by using one of scrambling codes included in the scrambling code set index; and
transmitting, by the femto BS, the IWS contents.

25. A method of transmitting an Inter Working Signal (IWS) for allowing a Mobile Station (MS) to recognize existence of a femto Base Station (BS) in a wireless communication system in which a macro cell and a femto cell coexist, the method comprising:
transmitting, by a macro BS, a scrambling code set index and a physical cell IDentifier (ID) and Identification-index (I-index) of the femto BS to the femto BS;
generating, by the femto BS, the IWS contents comprising a first bit-stream consisting of some bits of the physical cell ID, a power-saving mode indicator, and a block code;
performing, by the femto BS, scrambling on the IWS contents by using a scrambling code having the same index as a combination of a second bit-stream consisting of the remaining bits of the physical cell ID other than the first bit-stream, and the I-index among scrambling codes included in the scrambling code set index; and
transmitting, by the femto BS, the IWS contents.
